(19) United States
(12) Patent Application Publication
(10) Pub. No.: US 2026/0002631 A1
(43) Pub. Date: Jan. 1, 2026

(54) COUPLING ASSEMBLY HAVING DUAL-SCREW ENGAGEMENT STRUCTURE

(71) Applicant: TORDER CO., LTD., Seoul (KR)

(72) Inventor: Jeong Jin LEE, Seoul (KR)

(21) Appl. No.: 19/237,489

(22) Filed: Jun. 13, 2025

(30) Foreign Application Priority Data
Jun. 28, 2024 (KR) 10-2024-0085041

(51) Int. Cl. F16M 11/20; F16M 11/04

(52) U.S. Cl. CPC F16M 11/20; F16M 11/04

(57) ABSTRACT

An embodiment relates to a coupling assembly having a dual-screw structure. The coupling assembly includes: a sliding body formed in a planar shape in a longitudinal direction; an upper support coupled to the sliding body; and a lower support coupled to the sliding body. The sliding body has a plurality of projections formed on an inner surface thereof. The upper support is brought into close contact with and fixed to an upper surface of an object to which the coupling assembly is mounted, and includes an upper horizontal support formed in a plate shape in a horizontal direction, and an upper vertical support formed in a plate shape in a direction vertically downward from the upper horizontal support such that a part of the upper support overlaps and is coupled with the sliding body.

### CROSS-REFERENCE TO RELATED APPLICATION

This application is based on and claims priority under 35 U.S.C. § 119 to Korean Patent Application No. 10-2024-0085041, filed on Jun. 28, 2024, in the Korean Intellectual Property Office, the disclosure of which is incorporated by reference herein in its entirety.

### BACKGROUND

### 1. Field

The present invention relates to a coupling assembly having a dual-screw structure, and more particularly, to a coupling assembly capable of adjusting its width through the dual-screw structure depending on the thickness of a table when securing a mounting device.

### 2. Description of the Related Art

With the rising cost of labor, an increasing number of restaurants are adopting kiosks. In fast-food restaurants primarily offering take-out services, customers place orders via large kiosks and pick up prepared food. However, in dine-in restaurants where tables are provided, large kiosks are less preferred.

To address this, restaurants tend to install tablet-type ordering devices on each table. However, as the types of tables used vary by restaurant, the thickness of the table tops also differs.

Conventionally, mounting devices were purchased and installed separately depending on the thickness of the table. However, purchasing mounting devices tailored to the thickness of each table was inconvenient.

Accordingly, there is a growing need for a fixing module that can accommodate a wide range of table top thicknesses through a dual-screw structure.

### SUMMARY

The present invention is directed to solving the problems of the related art described above, and it is an object of the present invention to provide a coupling module capable of adjusting its width according to the thickness of a table when securing a mounting bracket, through a dual-screw engagement structure.

However, the technical problems to be achieved by the present embodiment are not limited to those described above, and other technical problems may exist.

According to a first aspect of the present disclosure, a coupling assembly having a dual-screw engagement structure is provided. The coupling assembly includes a sliding body configured in a planar shape in a longitudinal direction, an upper support coupled to the sliding body, and a lower support coupled to the sliding body. The sliding body includes a plurality of protrusions formed on an inner surface. The upper support is configured to be in close contact with and fixed to an upper surface of an object to which the coupling assembly is mounted. The upper support includes an upper horizontal support formed in a horizontal plate shape and an upper vertical support formed in a vertical plate shape extending downward from the upper horizontal support, wherein a portion of the upper vertical support overlaps and is coupled with the sliding body. The lower support includes a lower vertical support formed in a vertical plate shape, in which a plurality of grooves are formed to engage with the plurality of protrusions, and a lower horizontal support formed in a vertical direction from the lower vertical support in a plate shape, to which a plurality of first height adjustment screws are coupled. Each groove is shaped to narrow in width in a specific direction to allow the protrusion to be engaged, and each first height adjustment screw is coupled with a second height adjustment screw that is configured to bring the coupling assembly into close contact with a bottom surface of the object.

The present invention allows the width of the coupling module to be adjusted through a dual-screw structure according to the thickness of a table, enabling secure mounting of the bracket.

### BRIEF DESCRIPTION OF THE DRAWINGS

FIGS. 1 to 3 are views illustrating a mounting device having a dual-screw engagement structure to which a coupling assembly according to an embodiment of the present invention is applied.

FIGS. 4 to 10C are views illustrating the coupling assembly according to an embodiment of the present invention.

FIG. 11 is a view showing one embodiment of a mounting device having a dual-screw engagement structure to which the coupling assembly according to an embodiment of the present invention is applied.

FIG. 12 is a view illustrating a battery holder of a mounting device having a dual-screw engagement structure according to an embodiment of the present invention.

FIG. 13 is a view showing an example in which a battery holder is applied to a mounting device having a dual-screw engagement structure according to an embodiment of the present invention.

### DETAILED DESCRIPTION

The present disclosure will now be described in detail with reference to the accompanying drawings. However, the present disclosure may be embodied in various different forms and is not limited to the embodiments described herein. The drawings are provided to facilitate understanding of the embodiments disclosed in this specification and are not intended to limit the technical spirit disclosed herein. All terms, including technical and scientific terms, used herein should be interpreted as having meanings generally understood by those skilled in the art to which the present disclosure pertains. Unless otherwise defined, terms should not be interpreted as having overly idealistic or restrictive meanings and should be construed to have meanings consistent with related technical literature and the context of the present disclosure.

To clearly describe the present invention in the drawings, portions not related to the explanation may be omitted, and the sizes, shapes, and forms of respective elements shown in the drawings may vary. The same or similar reference numerals are assigned to the same or similar parts throughout the entire specification.

Throughout this specification, when it is stated that one component is “connected (attached, contacted, or coupled)” to another, it includes not only a case where they are “directly connected (attached, contacted, or coupled)” but also a case where they are “indirectly connected (attached, contacted, or coupled)” with other components interposed therebetween. In addition, when a component is stated to “include (have or be provided with)” another component, it does not exclude other components unless explicitly stated otherwise, and may further include additional components.

In this specification, the term “unit” refers to a component that may be implemented by hardware, software, or a combination of both. A single unit may be implemented by two or more hardware components, and two or more units may be implemented by a single hardware component. The term “˜unit” is not limited to either software or hardware, and may be implemented as a storage medium that can be addressed or as one or more processors configured to execute corresponding functions. For example, a “˜unit” may include software components, object-oriented software components, class components, task components, processes, functions, attributes, procedures, subroutines, segments of program code, drivers, firmware, microcode, circuits, data, databases, data structures, tables, arrays, and variables. The functions provided within the components and “˜units” may be combined into a smaller number of components or “˜units,” or may be further divided into additional components or “˜units.” Furthermore, the components and “˜units” may be implemented to be executed by one or more CPUs within a device or a secure multimedia card.

The suffixes “module” and “unit” used for various components described below are assigned merely for convenience in drafting this specification and are used interchangeably without implying any difference in function or role. In describing the embodiments disclosed herein, detailed descriptions of related known technologies may be omitted if it is determined that they would unnecessarily obscure the gist of the present invention.

Ordinal terms such as “first,” “second,” and the like used in this specification are intended only to distinguish one component from another and do not imply any order or relationship between the components. For example, a “first component” may be referred to as a “second component,” and similarly, a “second component” may be referred to as a “first component.” Also, unless explicitly stated otherwise, singular expressions include plural meanings as well.

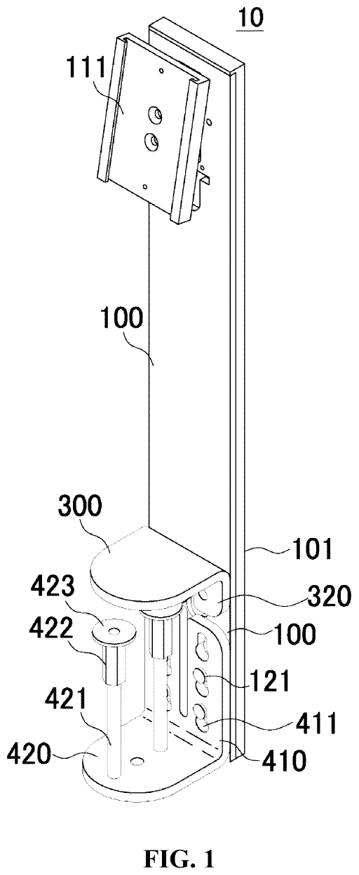

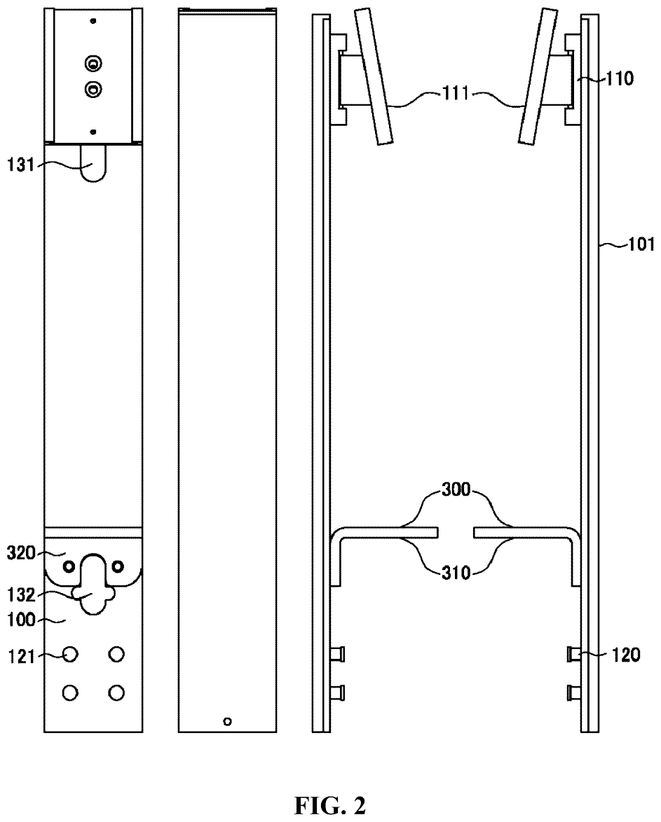

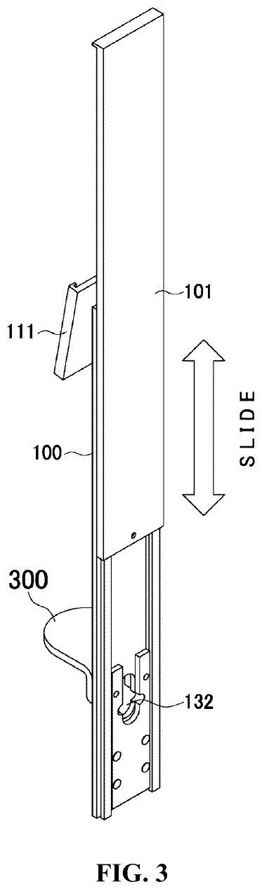

FIGS. 1 to 3 are views illustrating a mounting device having a dual-screw coupling structure according to an embodiment of the present invention.

Referring to FIGS. 1 to 3, the mounting device 10 of the present invention includes a sliding body 100, a sliding cover 101, a mounting bracket 110, a display coupling part 111, a projection 120, a projection head 121, an upper cable inlet 131, a lower cable inlet 132, an upper support 300, and a lower support 400. The upper support 300 and the lower support 400 may be collectively referred to as a coupling assembly.

The sliding body 100 may be configured in a planar form along the longitudinal direction. The sliding cover 101 may be slidably disposed on the rear side of the sliding body 100 along the longitudinal direction to open and close. An internal space through which a cable passes is formed between the sliding body 100 and the sliding cover 101, and the cable passing through the internal space is prevented from being exposed to the outside.

The mounting bracket 110 may include the display coupling part 111 at one end of the sliding body 100 and may be configured to rotate left and right by a predetermined angle. The display coupling part 111 may be configured to couple with a display mounting module 500 on which a display is mounted. The display coupling part 111 may be coupled to the display mounting module 500 in a sliding manner. The display mounting module 500 may include a charging port that receives power from an external power source. The display mounting module 500 may also include a wireless charging module. A heat sink may be disposed between the wireless charging module and the display to prevent heat generated during wireless charging from being transmitted to the inside of the display. The display may be a communicable computing terminal device such as a tablet or smartphone.

Although not shown in the drawings, the display coupling part 111 and the display mounting module 500 may be coupled in a configuration in which each includes a male pogo pin and a female pogo pin, respectively, to transmit and receive power. The pogo pin included in the display coupling part 111 may receive power from a battery mounted in a battery holder or from a commercial power source, and supply power to the pogo pin included in the display mounting module 500. The male and female pogo pins may include magnets with magnetic properties, and the positive and negative electrodes may be connected by magnetic force.

The projection 120 may be formed on the sliding body 100 and may be engaged with a groove 411 formed in the lower support 400, which will be described later. The projection 120 may include a projection head 121 at its end that has a larger surface area than the projection 120 itself, such that it does not disengage from the groove 411 unless an external force is applied.

The upper cable inlet 131 and the lower cable inlet 132 may be formed at the upper and lower portions, respectively, along the longitudinal direction of the sliding body 100. A cable may pass through the upper cable inlet 131, the lower cable inlet 132, and the space between the sliding body 100 and the sliding cover, supplying power to the battery or the display.

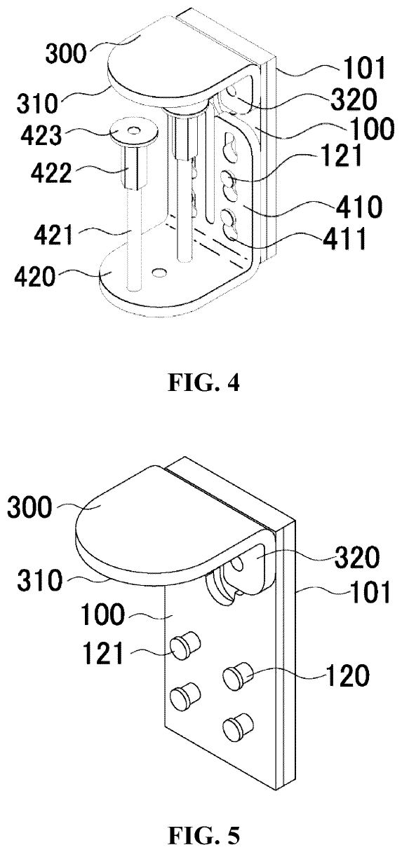

The coupling assembly including the upper support 300 and the lower support 400 may be coupled to the sliding body 100 such that the mounting device 10 is mounted to an object. In this case, the coupling height can be adjusted by the engagement positions of the plurality of projections 120 formed on the sliding body 100 and the plurality of grooves 411 formed on the lower support 400. In addition, the coupling height can be adjusted using the dual-screw structure of the lower support 400. A detailed description of the coupling assembly will be provided with reference to FIGS. 4 to 10.

In an additional embodiment of the present invention, the sliding body 100 may further include a rotation cover that is rotatably opened and closed along a direction defined by a plurality of hinges formed in the longitudinal direction. This configuration allows the cover to be opened and closed in spaces with low ceilings.

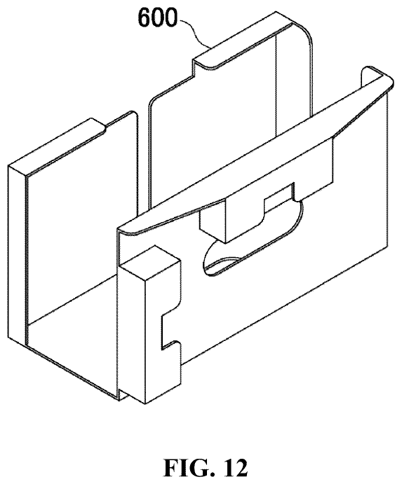

Although not shown in the drawings, the mounting device 10 may further include a card reader coupling part and a battery holder 600. The card reader coupling part may be configured to allow a card reader to be coupled adjacent to the mounting bracket 110 on the sliding body 100. A detailed description of the battery holder 600 will be provided with reference to FIG. 12.

FIGS. 4 to 10 are diagrams illustrating the coupling assembly of the mounting device 10 having a dual-screw coupling structure according to an embodiment of the present invention.

Referring to FIG. 4, the coupling assembly having a dual-screw structure includes a sliding body 100, an upper support 300, and a lower support 400. The sliding body 100 may have a plurality of projections 120 formed on its inner surface. The upper support 300 and the lower support 400 may each be configured with a plurality of planar surfaces. However, the configurations of the upper support 300 and the lower support 400 are not limited thereto.

The upper support 300 may be brought into close contact with and fixed to the upper surface of an object on which the coupling assembly is mounted. It may include an upper horizontal support 310 formed in a plate shape in the horizontal direction, and an upper vertical support 320 formed in a plate shape in a vertically downward direction from the upper horizontal support 310 so as to overlap and couple with a portion of the sliding body 100.

The lower support 400 may include a lower vertical support 410 formed in a plate shape in the vertical direction and having a plurality of grooves 411 that are engaged with a plurality of projections 120, and a lower horizontal support 420 formed in a plate shape in a vertically upward direction from the lower vertical support 410, to which a plurality of first height adjustment screws 421 are coupled.

The groove 411 may have a narrowing shape in a predetermined direction such that the projection 120 is engaged by interference. The first height adjustment screw 421 may be coupled to a second height adjustment screw 422 that is configured to bring the coupling assembly into close contact with the lower surface of the object.

Referring to FIG. 5, the upper support 300 may have a “¬”-shaped structure. However, the shape of the upper support 300 is not limited thereto.

To ensure frictional force as described for the upper support 300 in FIG. 4, a first friction portion having a predetermined frictional force may be formed on the bottom surface of the upper horizontal support 310. The first friction portion may be formed by directly processing the upper horizontal support 310 or by attaching a separate surface material such as non-woven fabric.

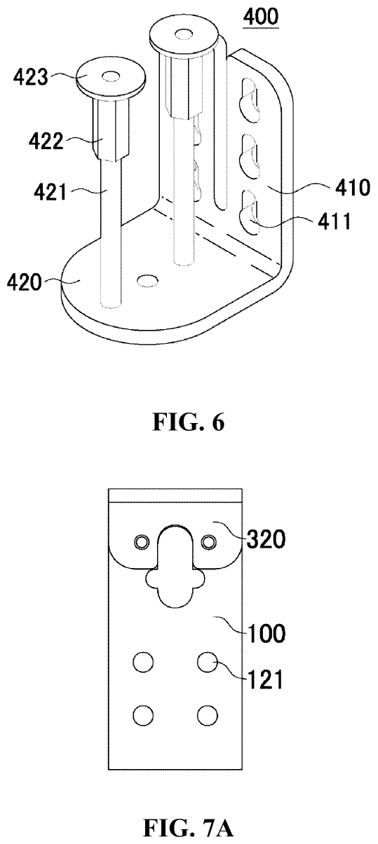

Referring to FIG. 6, the lower support 400 may have a “└”-shaped structure. Alternatively, although not shown in the drawings, the lower support 400 may have a “├”-shaped structure. However, the shape of the lower support 400 is not limited thereto.

In the case where the lower support 400 has a “└”-shaped structure, the lower vertical support 410 may have grooves 411 that are engaged with the projections 120 of the sliding body 100. The lower horizontal support 420, which extends in the horizontal direction, may have a plurality of holes into which the first height adjustment screws 421 are inserted.

The plurality of grooves 411 may be formed to narrow in the longitudinal direction such that the projections 120 are caught. The first height adjustment screw 421 may be coupled with the second height adjustment screw 422, which is configured to press the mounting device 10 against the lower surface of the object. Since the second height adjustment screw 422 is brought into contact with the lower surface of the object, it may be formed with a larger diameter than the first height adjustment screw 421 to secure sufficient friction. A surface material such as non-woven fabric may be attached to it. Furthermore, the portion of the second height adjustment screw 422 that contacts the object may be formed as a second height adjustment screw head 423 having a larger surface area, in order to maximize the friction.

Although not shown in the drawings, in the case where the lower support 400 has a “├”-shaped structure, it may further include an extended lower vertical support 410 that extends in the direction of the lower vertical support 410 from the intersection of the lower vertical support 410 and the lower horizontal support 420. A groove 411 may be formed in a direction symmetrical to the groove 411 of the lower vertical support 410 with respect to the lower horizontal support 420.

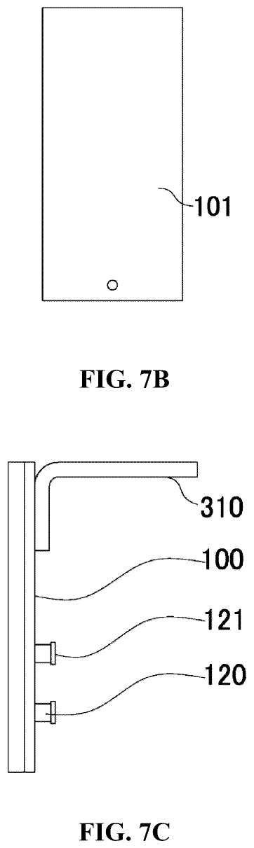

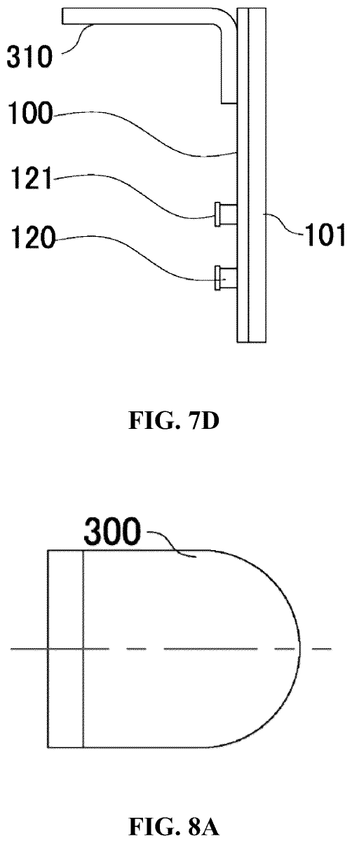

Referring to FIGS. 7A to 7D, the front view, rear view, left side view, and right side view of the upper support 300 can be identified. As shown in FIG. 7A, the upper support 300 may include an upper horizontal support 310 and an upper vertical support 320 perpendicular to the upper horizontal support 310. The upper vertical support 320 may be coupled to the sliding body 100. As shown in FIG. 7B, the rear view of the upper support 300 may be configured with the sliding cover 101. A space between the sliding body 100 and the sliding cover 101 may allow cables or wires to pass through, providing video, power, or communication. Referring to the left and right side views of the upper support 300 shown in FIGS. 7C and 7D, the projections 120 of the sliding body 100 may be coupled to the lower support 400, and projection heads 121 having a larger diameter than the projections 120 may be formed at the ends of the projections to prevent disengagement.

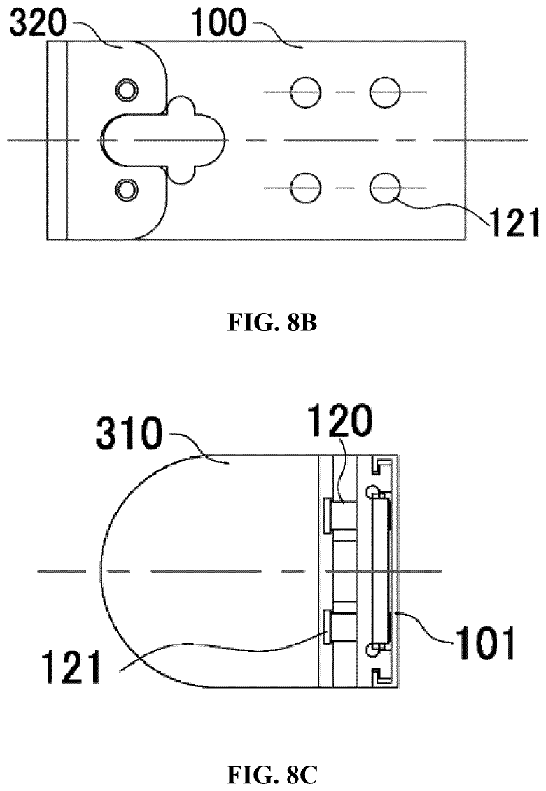

Referring to FIGS. 8A to 8C, the top view, front view, and bottom view of the upper support 300 can be identified. As shown in FIG. 8A, the upper surface of the upper support 300 is flat. The front view may be replaced by the description provided in FIG. 7. As shown in FIG. 8C, the bottom view of the upper support 300 reveals the structure of the sliding cover 101 located at the rear of the sliding body 100. The sliding cover 101 may have rails on its edges, and it may open and close by sliding along rails corresponding to those of the sliding body 100. However, the structure of the sliding cover 101 is not limited to this configuration.

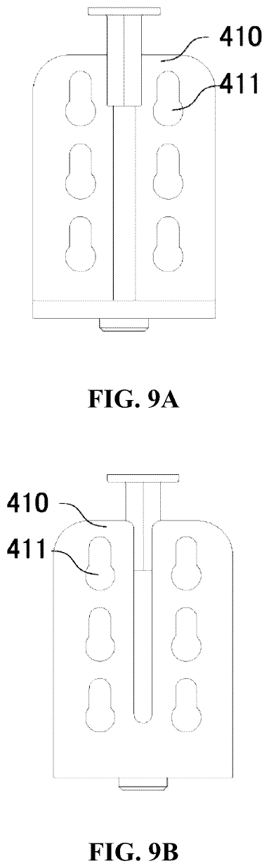

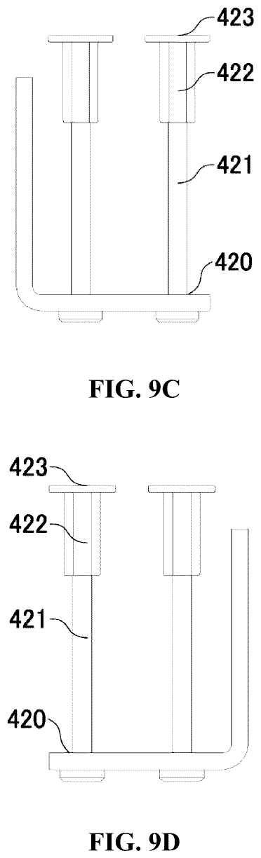

Referring to FIGS. 9A to 9D, the front view, rear view, left side view, and right side view of the lower support 400 can be identified. As shown in FIGS. 9A and 9B, grooves 411 that couple with the upper support 300 may be formed on the lower vertical support 410 of the lower support 400, which is configured in the longitudinal direction. The grooves 411 may include pairs of grooves formed in parallel, and these groove pairs may be formed in multiple rows in the vertical direction on the lower vertical support 410. The projections 120 may also include pairs of projections formed in parallel, and the projection pairs may be formed in multiple rows in the vertical direction on the body. The coupling between the groove pairs and the projection pairs allows the first height of the upper horizontal support 310 and the lower horizontal support 420 to be adjusted.

Additionally, a first height adjustment screw 421 may be coupled to the lower horizontal support 420, which is configured in the horizontal direction of the lower support 400. The first height adjustment screw 421 may be coupled to a second height adjustment screw 422 configured to provide friction by pressing the coupling assembly against the lower surface of an object. Referring to the left and right side views of the lower support 400 shown in FIGS. 9C and 9D, multiple first height adjustment screws 421 and second height adjustment screws 422 may be included. Furthermore, the second height adjustment screw 422 may have a second height adjustment screw head 423 with a larger surface area where it contacts the object, in order to maximize the friction.

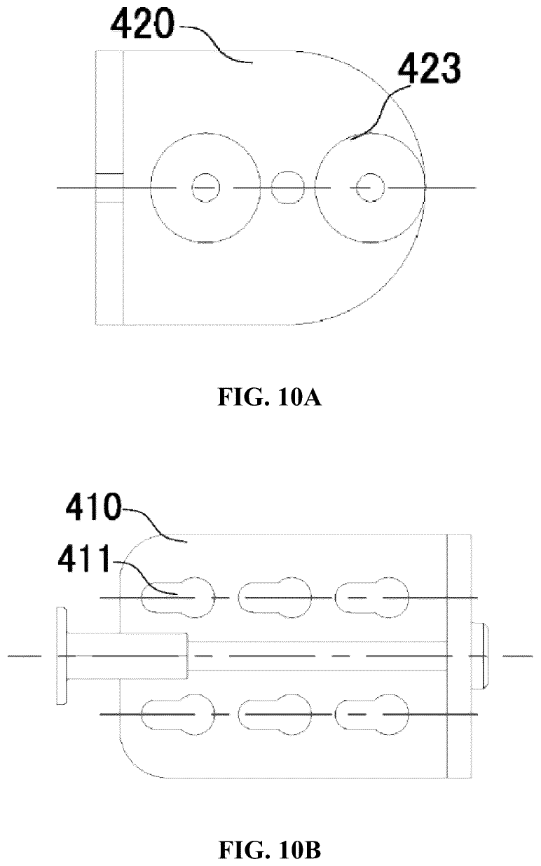

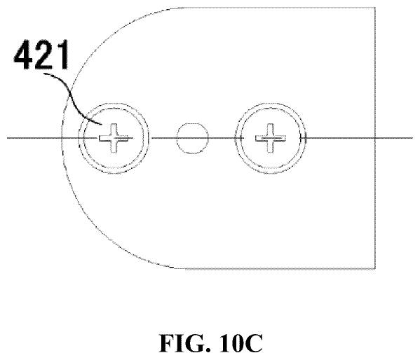

Referring to FIGS. 10A to 10C, the top view, front view, and bottom view of the lower support 400 can be identified. As shown in FIG. 10A, multiple second height adjustment screws 422 can be identified in the top view of the lower support 400. The front view may be replaced by the description provided in FIG. 9. Referring to the bottom view of the lower support 400 shown in FIG. 10C, multiple first height adjustment screws 421 can be identified.

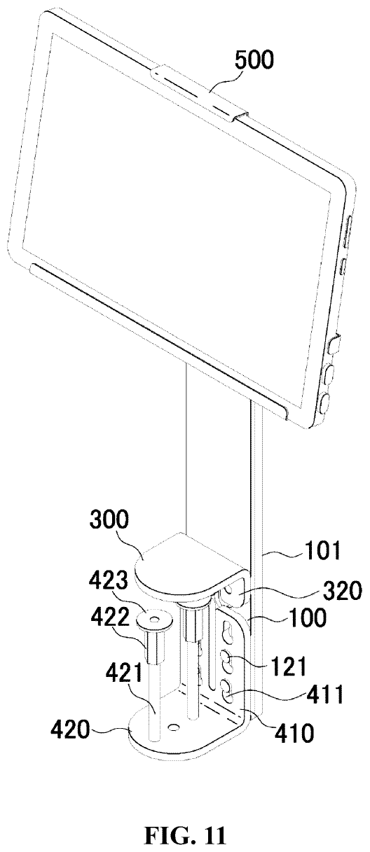

FIG. 11 illustrates an example of a mounting device 10 having a dual-screw coupling structure in which the coupling assembly according to an embodiment of the present invention is applied.

Referring to FIG. 11, the mounting device 10 having a dual-screw structure includes a display mounting module 500 coupled to the display coupling part 111. The first height of the upper horizontal support 310 and the lower horizontal support 420 can be adjusted through the coupling of the projections 120 of the sliding body 100 and the grooves 411 of the lower support 400. The second height of the upper horizontal support 310 and the lower horizontal support 420 can be adjusted by the first height adjustment screw 421. The third height can be adjusted by the second height adjustment screw 422.

FIG. 12 is a diagram for explaining the battery mounting unit 600 of the mounting device 10 having a dual-screw coupling structure according to an embodiment of the present invention.

Referring to FIG. 12, the battery mounting unit 600 includes a space in which a battery can be mounted, and may be configured such that the top surface and two opposing side surfaces are open. It may include a battery that supplies power to the display and the card reader.

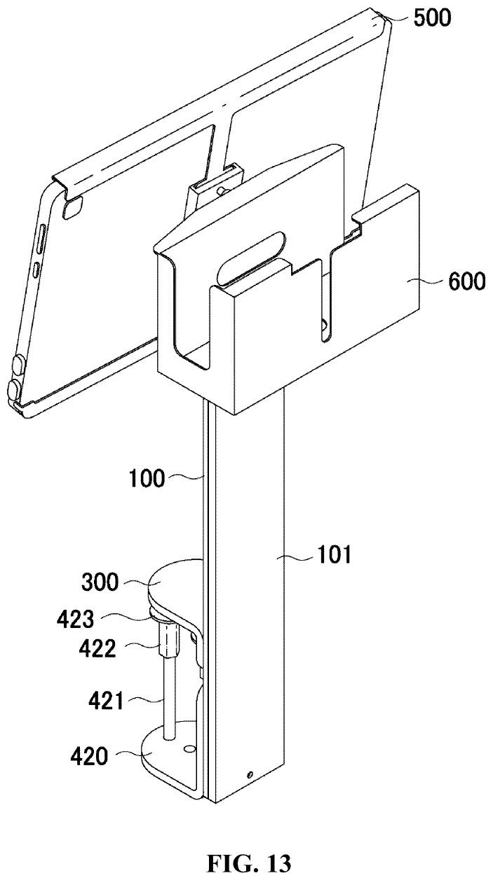

FIG. 13 illustrates an example in which the battery mounting unit 600 is applied to the mounting device 10 having a dual-screw coupling structure according to an embodiment of the present invention.

Referring to FIG. 13, the battery mounting unit 600 of the present invention may be attached to the rear surface of the sliding body. Although not illustrated, the battery mounting unit 600 of the present invention may also be attached to the lower surface of the lower support 400.

Those of ordinary skill in the art to which the present disclosure pertains will understand that various modifications can be made without departing from the spirit or essential features of the present disclosure based on the above description. Therefore, the embodiments described above are merely illustrative in every aspect and should not be construed as limiting. The scope of the present disclosure should be interpreted based on the claims that follow, and all modifications or alterations derived from the meaning, scope, and equivalents of the claims should be construed as falling within the scope of the present disclosure.

What is claimed is:

1. A coupling assembly having a dual-screw structure, comprising:
a sliding body configured in a planar shape along a longitudinal direction;
an upper support coupled to the sliding body; and
a lower support coupled to the sliding body,
wherein the sliding body includes a plurality of projections formed on an inner surface thereof,
wherein the upper support is closely adhered and fixed to an upper surface of an object to which the coupling assembly is mounted, and includes:
an upper horizontal support formed in a plate shape in a horizontal direction; and
an upper vertical support formed in a plate shape in a downward vertical direction from the upper horizontal support, such that a part of the upper support overlaps and is coupled with the sliding body,
wherein the lower support includes:
a lower vertical support formed in a plate shape in a vertical direction and having a plurality of grooves coupled with the plurality of projections; and
a lower horizontal support formed in a plate shape in an upward vertical direction from the lower vertical support and having a plurality of first height adjustment screws,
wherein each of the grooves has a narrowing shape in a predetermined direction such that the projection is engaged and locked, and
wherein each of the first height adjustment screws is coupled with a second height adjustment screw configured to press the coupling assembly against a lower surface of the object.

2. The coupling assembly having a dual-screw structure of claim 1,
wherein a first friction portion having a predetermined frictional force is formed on a bottom surface of the upper horizontal support configured in the horizontal direction of the upper support.

3. The coupling assembly having a dual-screw structure of claim 1,
wherein the lower support is formed in at least one of an “└” shape or an “├” shape.

4. The coupling assembly having a dual-screw structure of claim 3,
wherein when the lower support is formed in the “└” shape,
the grooves coupled with the sliding body are formed on the lower vertical support configured in the vertical direction of the lower support, and
the first height adjustment screws are coupled to the lower horizontal support configured in the horizontal direction of the lower support.

5. The coupling assembly having a dual-screw structure of claim 3,
wherein when the lower support is formed in the “├” shape,
an extended lower vertical support is further included, extending in a direction of the lower vertical support from a position where the lower vertical support and the lower horizontal support meet, and
another groove is formed in the extended lower vertical support, in a direction symmetrical to the groove of the lower vertical support with respect to the lower horizontal support.

6. The coupling assembly having a dual-screw structure of claim 1,
wherein the grooves include groove pairs formed in parallel,
wherein the groove pairs are formed in plural along a vertical direction of the lower vertical support,
wherein the projections include projection pairs formed in parallel,
wherein the projection pairs are formed in plural along a vertical direction of the sliding body, and
wherein a first-stage height of the upper horizontal support and the lower horizontal support is adjusted through the engagement of the groove pairs and the projection pairs.

7. The coupling assembly having a dual-screw structure of claim 6,
wherein a second-stage height of the upper horizontal support and the lower horizontal support is adjusted through the first height adjustment screws.

8. The coupling assembly having a dual-screw structure of claim 7,
wherein a third-stage height of the upper horizontal support and the lower horizontal support is adjusted through the second height adjustment screws.
